(19) United States
(12) Patent Application Publication
(10) Pub. No.: US 2008/0011121 A1
(43) Pub. Date: Jan. 17, 2008

(54) Functional Pedal Mechanism

(76) Inventor: Jorg Topfer, Jena (DE)

Correspondence Address: G Scott Dorland;Morriss O'Bryant Compagni, 136 South Main, Suite 700, Salt Lake City, UT, 84101, US

(21) Appl. No.: 11/597,698

(22) PCT Filed: May 26, 2005
(86) PCT No.: PCT/EP05/05687

§ 371 Date: Nov. 27, 2006

(30) Foreign Application Priority Data
May 26, 2004 (DE) 10 2004 026 724.3

(51) Int. Cl. B62M 3/08; A63B 22/06

(52) U.S. Cl. 74/594.6; 482/57

(57) ABSTRACT

The present invention relates to a pedal mechanism for use in a bicycle, ergometer or other therapy, rehabilitation or fitness device for active and/or passive bending and stretching of the legs or for carrying out combined movement sequences that include this movement. The pedal mechanism substantially comprises a support (19) and a shoe support (15) that is movably arranged on the support (19). The support (19) is rotatably arranged on a pedal shaft (17) by means of the bearing sleeves (21). The pedal shaft (17) is non-rotatably connected to a sleeve (23). The sleeve (23) has a guide groove (25) in which a cam arranged on the shoe support (15) engages. When the pedal shaft (17) is rotated relative to the shoe support (15) the shoe support (15) is swivelled.

### FIELD OF THE INVENTION

The invention relates to a pedal mechanism of a bicycle, fitness, rehabilitation or other device which is used in actively and/or passively bending and stretching the legs according to the pre-characterising clause of Claim 1.

### PRIOR ART

DE-A-43 46 183 relates to a bicycle pedal which has the property of improving blood circulation in the arch of the foot. For this purpose a massaging organ is provided on the pedal which on downward pedalling pushes on the arch of the foot and rolls thereon. The massaging organ comprises an eccentric part permanently arranged on the pedal shaft and which is coupled to the pedal shaft so as to rotate therewith. When the pedal crank arm is actuated the eccentric part executes a swivelling movement in a plane which is parallel to the plane of the pedal crank web. The eccentric part can be spherical or pear-shaped, in other words it projects from the plane of the shoe support.

DE 299-01-785-U1 discloses a connecting system for a bicycle pedal which preferably provides for effective decoupling between pedal and shoe in the event of a fall. The notch provided for this purpose in the region of the ball of the foot allows greater range of movement in the heel region.

U.S. Pat. No. 5,199,324 discloses a pedal arrangement for bicycles which may be arranged on the pedal crank at a predetermined angle. Rotation of the pedal crank varies the angle of inclination of the pedal. The angle of inclination of the pedal is the total of a first incremental angle of inclination, which is determined by a bevelled cam, and a second incremental angle of inclination, which is provided by an inclined pedal platform.

U.S. Pat. No. 4,599,915 discloses a pedal for use on any pedal-powered vehicles or devices and which can be adjusted in one to three planes. The pedal platform is swivellable and inclinable about a radial axis which is perpendicular to the pedal shaft. The platform may also be adjusted in terms of height by way of a spacing means. What is significant however is that a position of the pedal platform, once assumed, is fixed by means of pins, so during revolution of the pedal there is no mobility of the pedal platform with respect to the pedal shaft.

FR-A-2 661 651 discloses a bicycle pedal which during its revolution allows tilting of the pedal. The pedal platform rests on a centrally arranged bearing which allows rotation and tilting of the pedal. The extent of the tilting movement can be adjusted by a cone which is screwed onto the pedal shaft and is adjustably arranged thereon.

The prior art does not for example allow any rotational movement, required by the human functional anatomy, in the heel region of the foot which leads to a swivelling-rotational movement in the longitudinal axis of the foot (free or forced).

In the meantime it has become known that owing to the complex structure and function of the legs and feet, the human body is not compatible with rigidly progressing movements. To a large extent these aspects play a part in cycling, a form of movement and stress with a wide variety of adaptive requirements for coordination between structural elements predetermined by the bicycle construction and which demand forced movements and postures, and the human body and the kinematics, statics and functional concept thereof. In the writer's opinion these are contrary to a considerable extent. Apart from the positive conditioning and muscle training effect the wheel, in terms of its current constructional and functional elements, is a considerable destructor for human supporting apparatus.

Functional, Morphological Requirement—Description:

While, when the knee is bent, the human knee and foot allow a high range of movement, in particular in terms of the rotation and position with respect to each other, during the course of stretching, and therefore when transferring loads and forces, they increasingly demand an outward rotation of the foot with respect to the knee. The axis of rotation morphologically required for this is located in the region of the heels. The reasons for this lie inter alia with the axial skeleton, with what is referred to as the external tibial rotation that is determined by the ligaments, and in particular the morphological tibia torsion of approximately 20 degrees.

### OBJECT OF THE INVENTION

It is therefore the object of the present invention to provide a new pedal mechanism. The pedal mechanism should in particular provide an expedient solution that better matches the functional anatomy and morphology of the human body.

Description

According to the invention the object is achieved by a pedal mechanism according to the pre-characterising clause of Claim 1 in which the shoe support is movably arranged on the support in such a way that a swivelling movement at an angle to the longitudinal extension of the shoe support is made possible. The longitudinal axis is taken to mean the axis which extends in the longitudinal extension of a foot arranged on the shoe support. The movable shoe supporting surface has the advantage that at least one further plane of movement necessary for a sequence of movement corresponding to the morphology is added, i.e. with a circular pedalling movement or stretching movement of the legs, the foot can adopt a natural position, corresponding to the physiological conditions, relative to the rest of the body (free mobility). The pedal mechanism according to the invention has the advantage moreover that the functional anatomical kinesiology is satisfied and therefore the conventional stress-related damage to the knees and ankle joints does not occur. Use of the pedal mechanism according to the invention allows a swivelling movement in the plane of the shoe support for the first time.

The swivelling movement preferably extends along a curved path of movement. A swivelling movement along a curved path, preferably with a swivel guide in the region of the heels, is particularly advantageous physiologically. The curved path can for example correspond to a circular or elliptical path. According to a particularly preferred embodiment of the invention the shoe support can be swivelled in a plane which is parallel to the pedal shaft. This swivelling capacity of the shoe support is generally sufficient to counteract the known stress-related damage.

According to a preferred embodiment a forced swivelling movement may be generated in the plane of the shoe support in that a groove in a cam track form is formed on the pedal shaft and at the lower side of the shoe support a cam is formed and the cam meshes in the groove. A sleeve may however also be provided in which the cam track is formed and which is placed and fixed on the pedal shaft. The shoe support can be elongated in construction, so the entire foot can be supported thereon and may be embedded therein.

The shoe support is advantageously guided, by means of at least one slide/rail system provided on the support in a plane extending parallel to the pedal shaft, along a straight or curved path of movement. This is a simple and expedient construction to conform with the functional anatomy and morphology of the human body. One possible embodiment provides that the support has a heel support on which the shoe support is rotatably mounted, for example in the manner of a ball-and-socket joint, in the heel region.

The path of movement of the slide may be curved in the plane of the shoe support (two-dimensional) and in a specific embodiment also be curved out of the plane of the shoe support (three-dimensional path of movement). In the second case the foot executes a tilting movement in addition to the swivelling movement. This may for example be brought about in that a cam track is formed on the pedal shaft and connected to the shoe support in such a way that when the support rotates about the pedal shaft the shoe support executes a swivelling movement in the plane of the shoe support and out of this plane again. For example a truncated cone-shaped sleeve with a cam track may be non-rotatably arranged on the pedal shaft. In this case the shoe support can be supported on the truncated cone-shaped sleeve or the cam track on the one hand and on the pedal shaft on the other hand.

According to a preferred embodiment a slide is arranged on the support so it can be reciprocated and is reciprocated during operation by a gear which is driven by the pedal shaft that is non-rotatably connected to the pedal crank. As a result of this construction the shoe support is actively reciprocated during operation. One possible embodiment provides that provided on the support are two guide rods on which the slide is arranged so it can be reciprocated, that provided on the slide is a cam which engages in a first guideway on the pedal shaft permanently connected to the pedal crank, and that provided on the support is a second guideway in which a pin arranged on the shoe support engages. A swivelling and rotational movement can therefore be brought about by the two guideways.

A further embodiment provides that pivotally arranged on the support is an angle lever which with a first arm cooperates with the slide and with the second arm cooperates with an eccentric disc non-rotatably connected to the pedal shaft. During operation the angle lever is reciprocated by the eccentric disc and thus forces a corresponding movement of the slide and the shoe support arranged thereon. A further embodiment provides that provided on the support is a gear which is driven by the pedal shaft that is non-rotatably connected to the pedal crank, that provided on the gear is a movement converter (drive wheel) which is connected via a linkage to the slide. The rotational movement of the pedal shaft is converted into a reciprocal movement of the slide by the gear. As a result of the fact that at the back the support has an elongate extension to which a lever that is connected to the slide is rotatably linked, the slide can be reciprocated along a circular path.

The present invention also relates to a bicycle, ergometer or other therapy, rehabilitation or fitness device for active and/or passive bending and stretching of the legs or for carrying out combined movement sequences that include this movement, in particular the complex movement sequences as a consequence thereof of the feet, comprising a pedal mechanism according to the invention.

The pedal mechanism is advantageously arranged on a pedal crank arm in such a way that the longitudinal axis of the shoe support, in the uppermost position of the pedal crank arm, extends substantially parallel to a plane which is defined by the rotating pedal crank arm, and in the lowermost position of the pedal crank arm, the longitudinal axis of the shoe support is arranged at an angle to this plane, i.e. the toe-end points outwards at least in a lowermost position. The pedal mechanism may also be arranged on a known movement rail. A movement converter is preferably provided which converts a stretching movement into a rotation of a pedal shaft. The rotating pedal shaft may then bring about a swivelling movement of the shoe support. Use of a lever arrangement which brings about swivelling of the shoe support on stretching of the leg is also conceivable.

The invention will be described by way of example hereinafter with reference to the figures, in which:

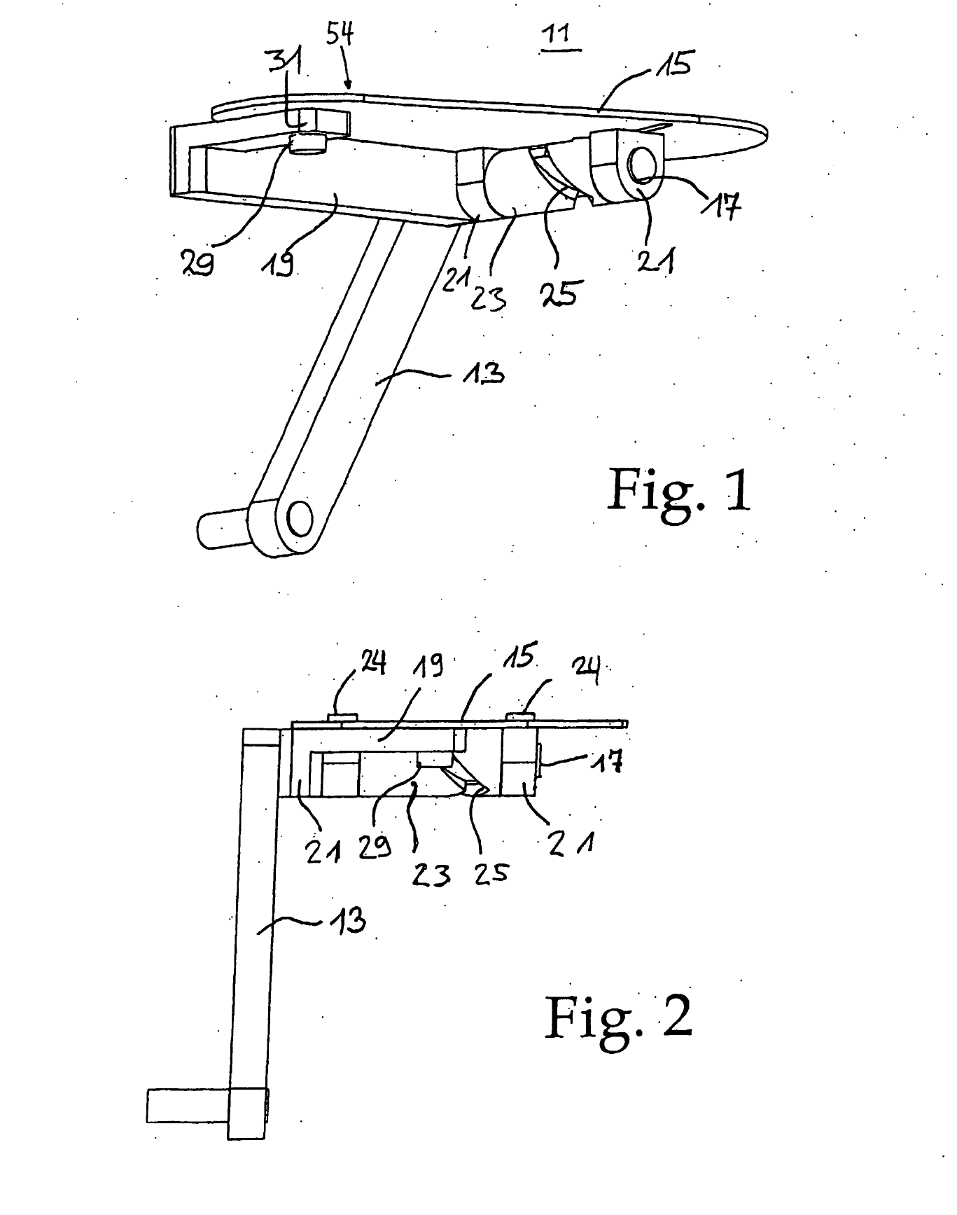

FIG. 1 shows a perspective view of an embodiment of a pedal mechanism according to the invention comprising pedal and shoe support;

FIG. 2 shows the pedal mechanism of FIG. 1 in a front view;

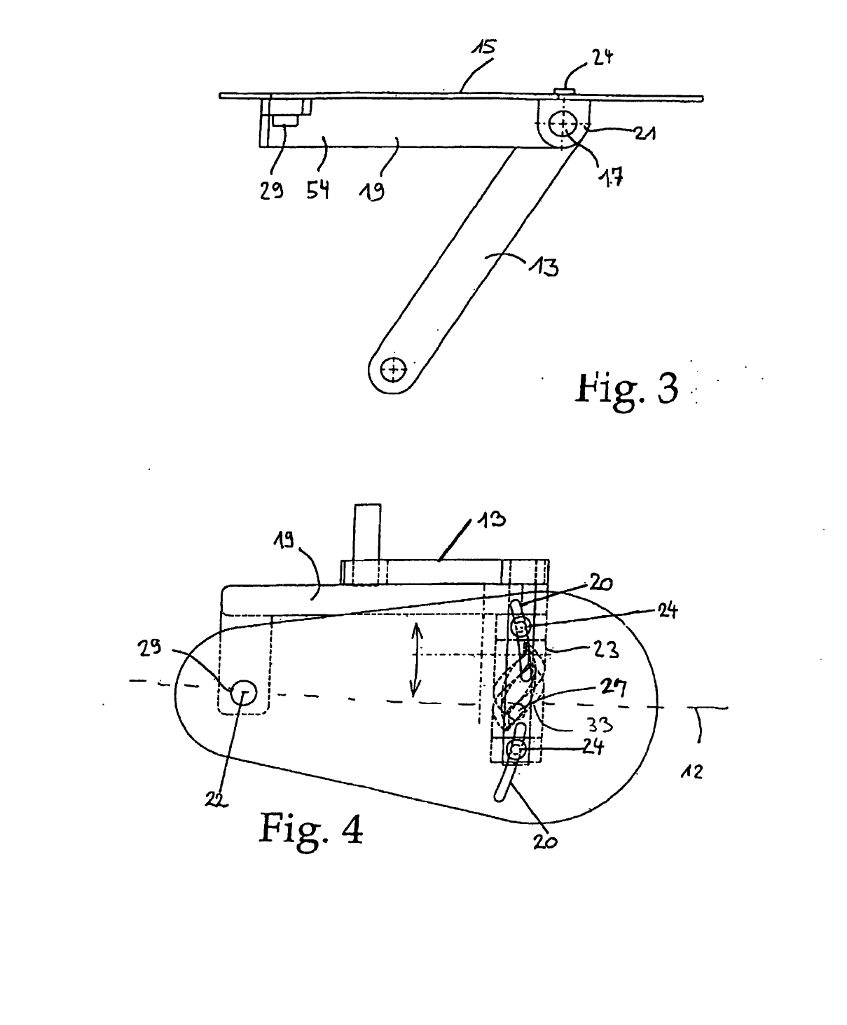

FIG. 3 shows the pedal mechanism of FIG. 1 in a side view;

FIG. 4 shows the pedal mechanism of FIG. 1 in a plan view;

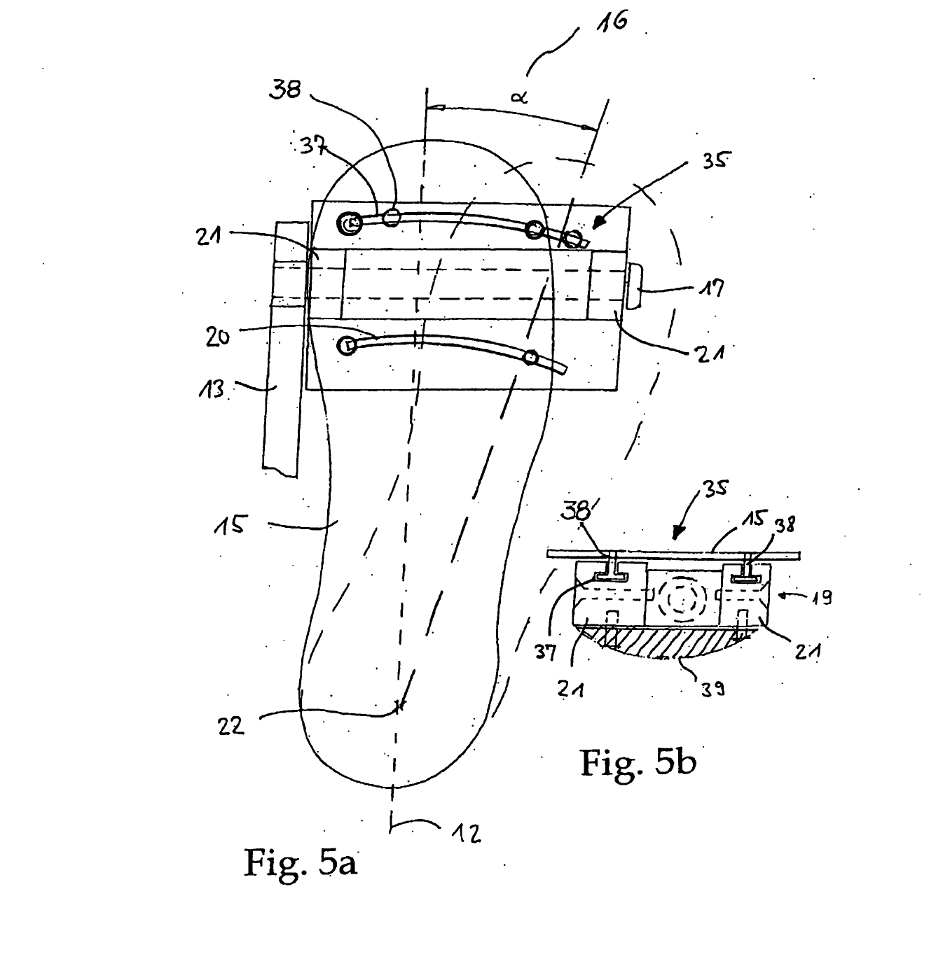

FIG. 5a shows a plan view, partially in section, of a second embodiment of the pedal mechanism with a slide/rail system;

FIG. 5b schematically and in cross-section shows the pedal mechanism of FIG. 5;

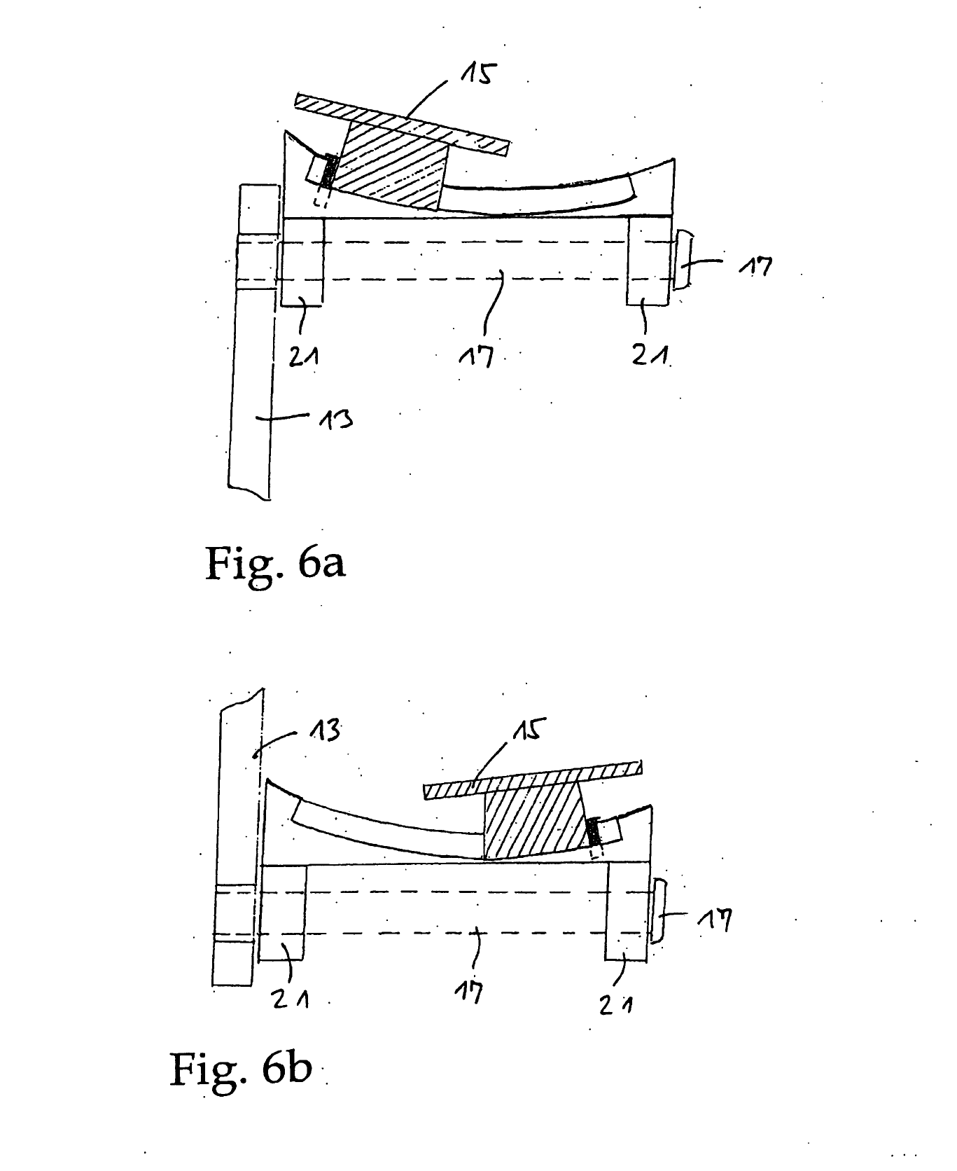

FIG. 6 schematically shows a third embodiment of the pedal mechanism with a path of movement curved in a trough shape;

a) in the case of the upper pedal crank arm position and

b) in the case of the lower pedal crank arm position;

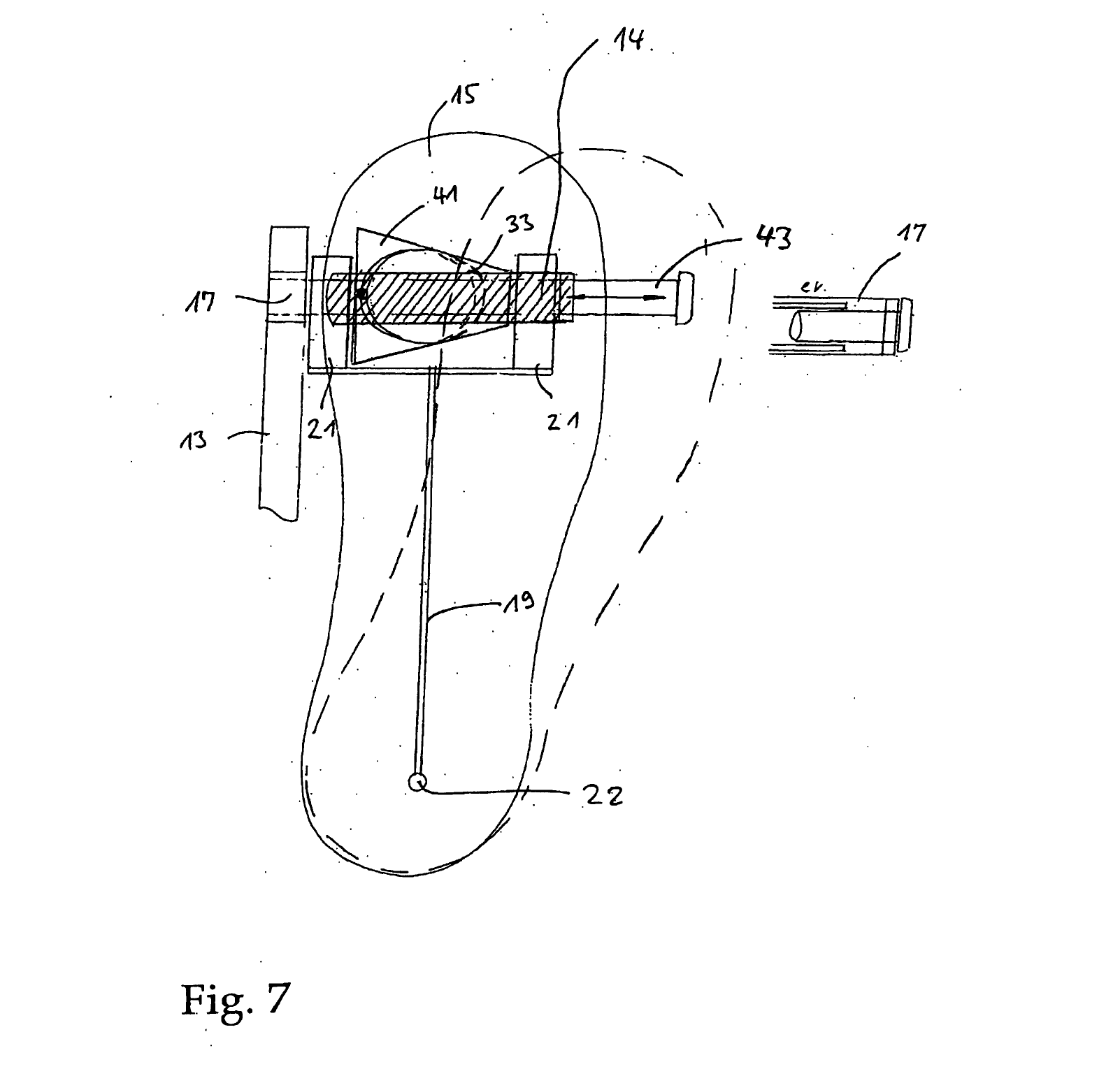

FIG. 7 shows a plan view of a fourth embodiment of the pedal mechanism with a cam track arranged on a truncated cone and a heel support as well as a telescopically extendable pedal shaft;

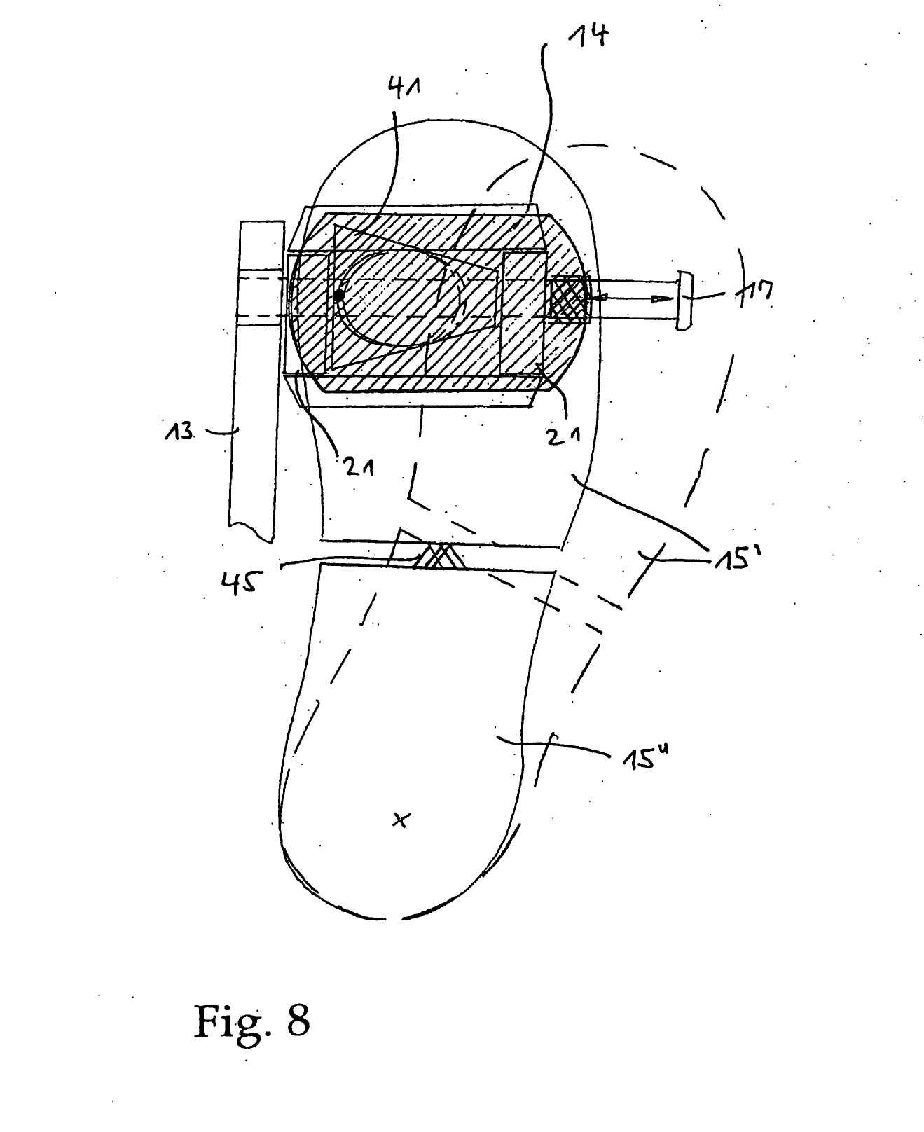

FIG. 8 shows a fifth embodiment of the pedal mechanism with a two-part shoe supporting surface and without heel support;

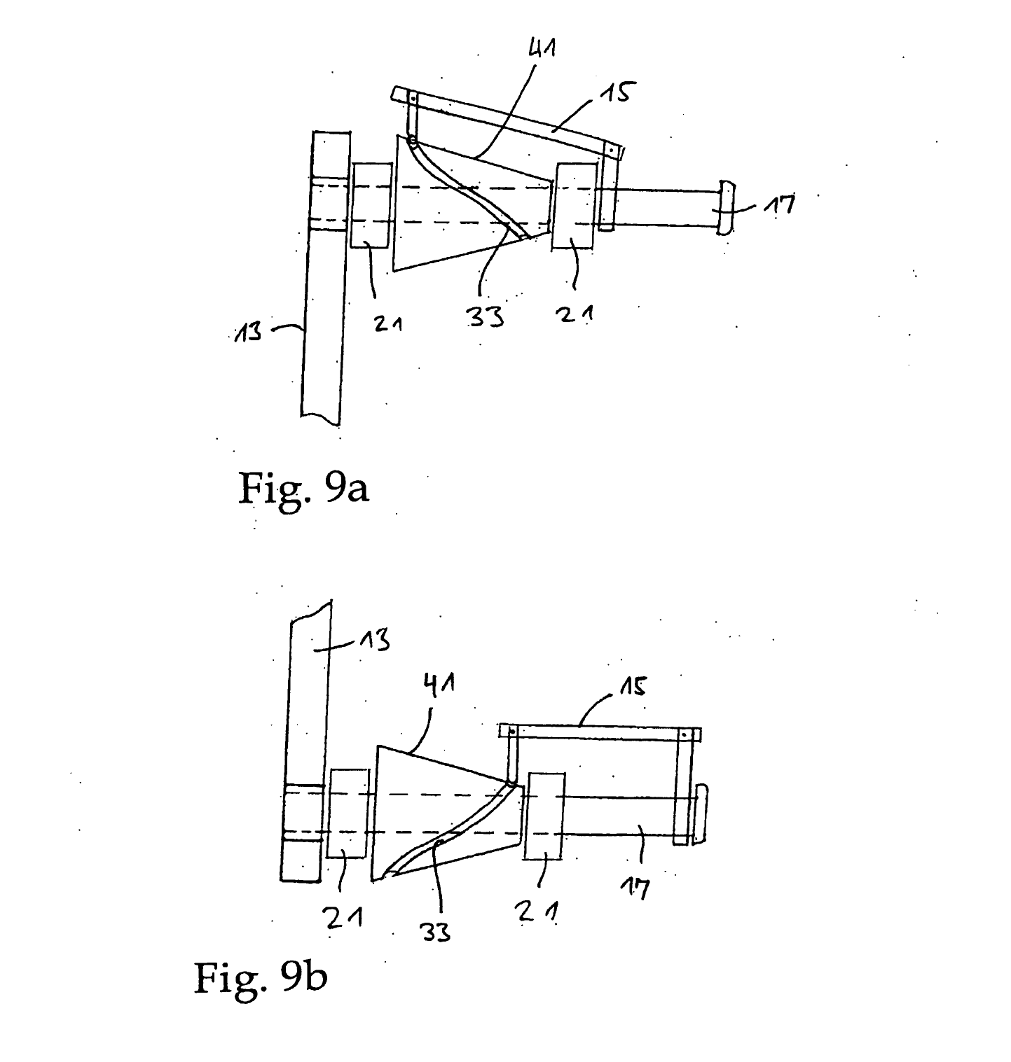

FIGS. 9a and b schematically show the position of the shoe supporting surface in various pedal crank arm positions in the embodiments according to FIGS. 7 and 8;

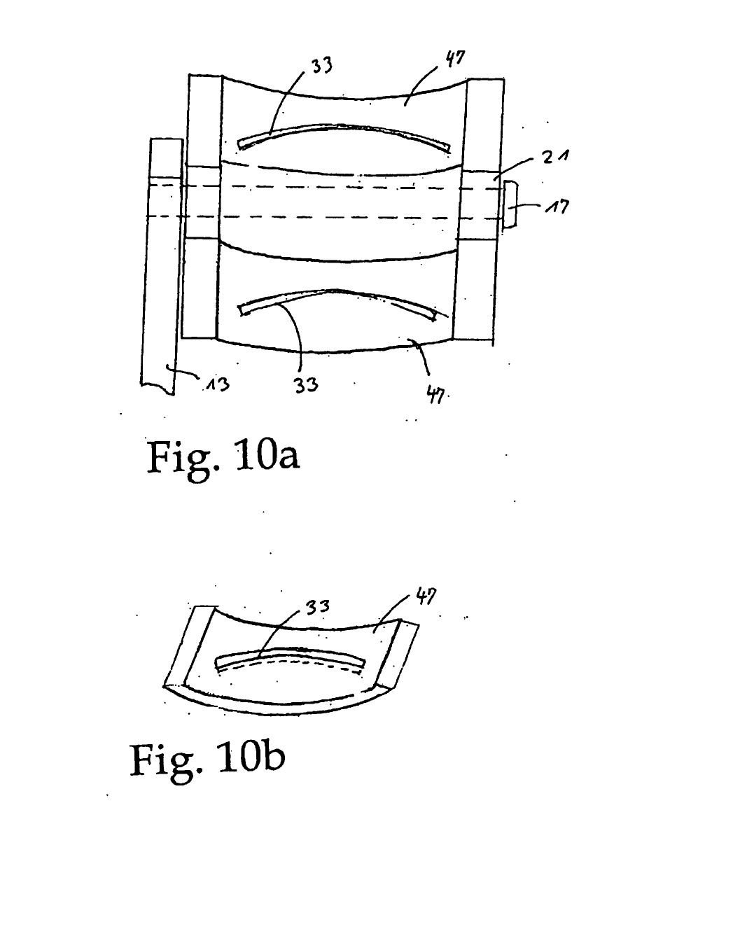

FIG. 10a schematically shows a sixth embodiment of a pedal mechanism with a slide-rail system (only rail system illustrated) with two pedal supports curved in a trough-shape arranged on the support with a cam track shape in the plane of the shoe support and cam track shape curved in a trough-shape with respect to the plane of the shoe support;

FIG. 10b shows a pedal support curved in a trough-shape according to FIG. 10a;

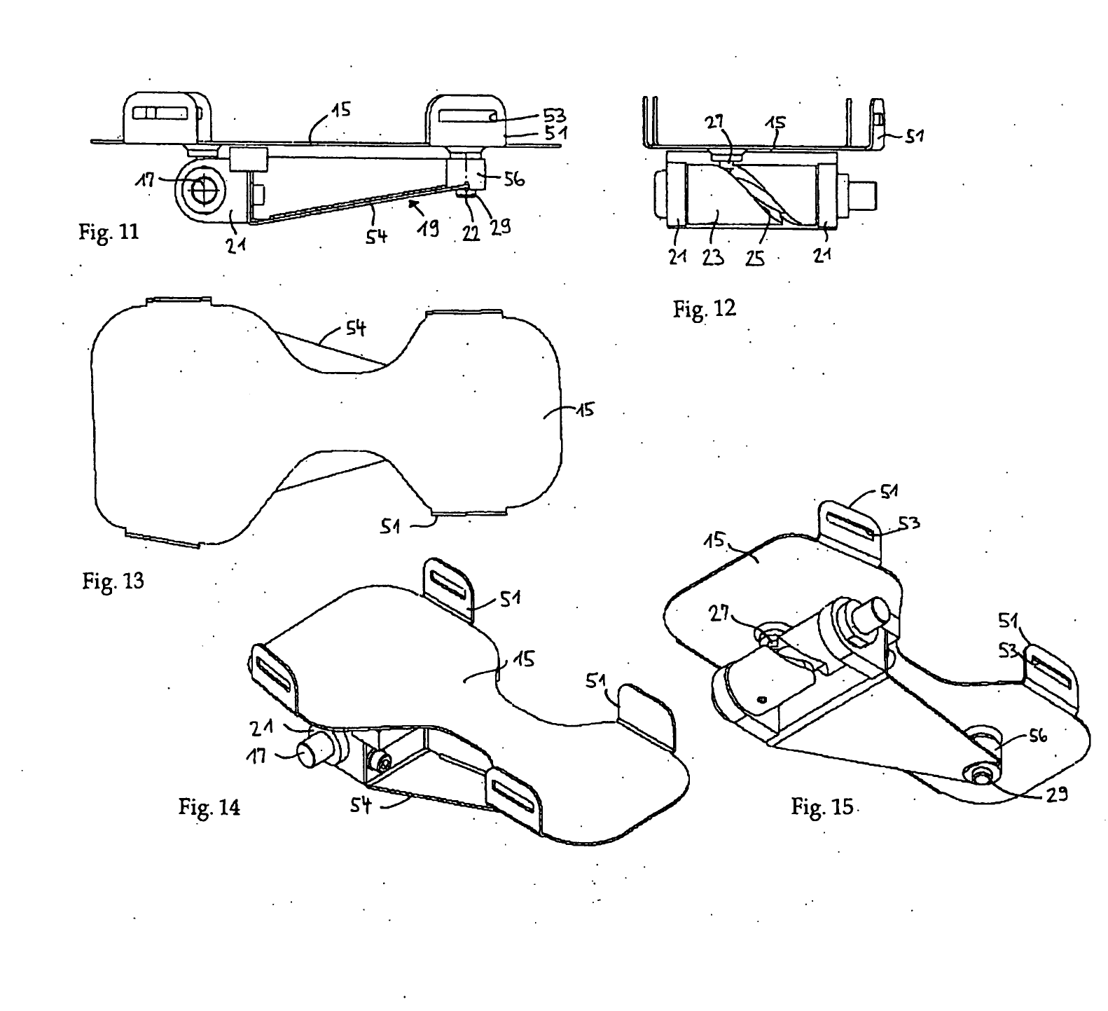

FIG. 11 shows a side view of a pedal mechanism according to the invention;

FIG. 12 shows a front view of the pedal mechanism of FIG. 11;

FIG. 13 shows a plan view of the pedal mechanism of FIG. 11;

FIG. 14 shows a perspective view of the pedal mechanism of FIG. 11 from below;

FIG. 15 shows a perspective view of the pedal mechanism of FIG. 11 from above;

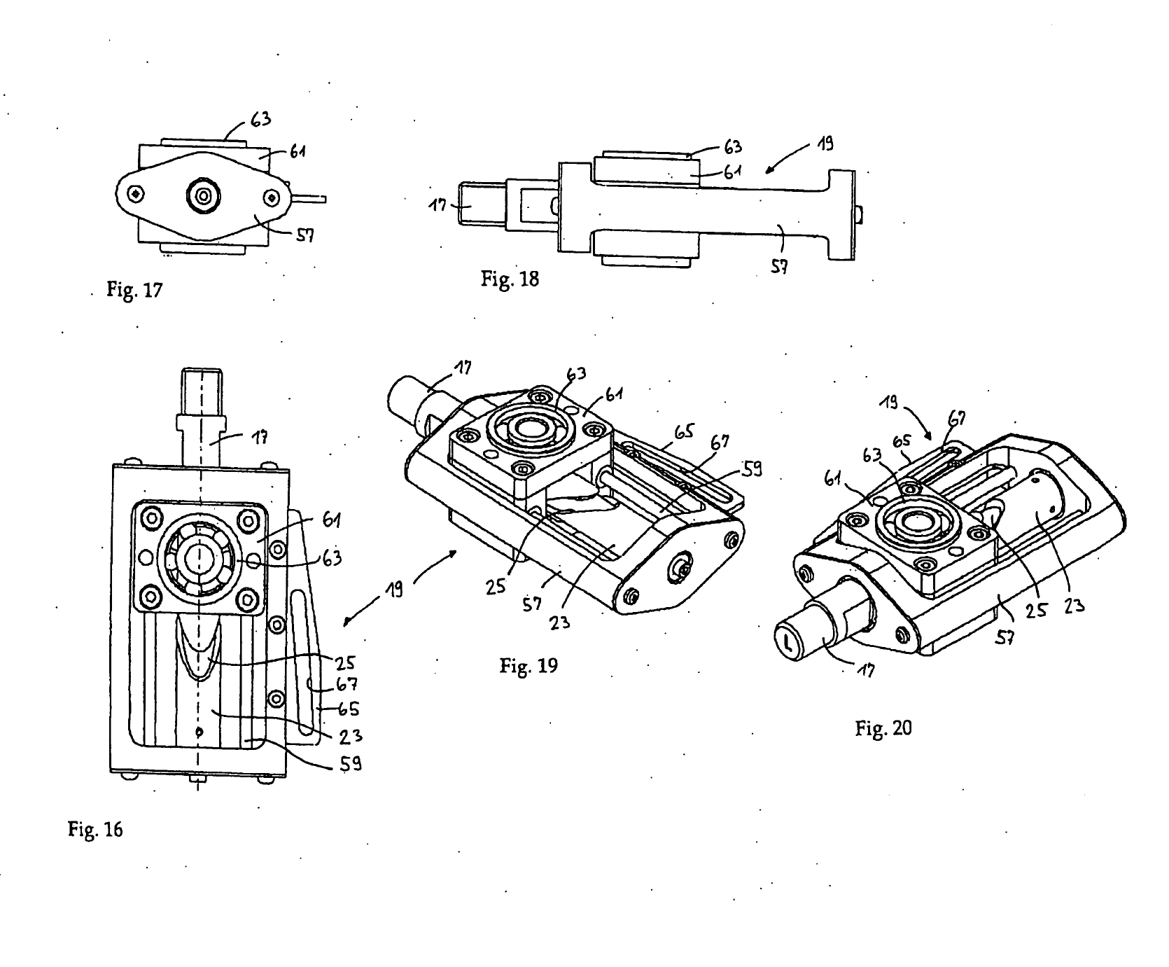

FIG. 16 shows a plan view of a seventh embodiment of a pedal mechanism with a reciprocal slide and a restricted guidance to generate a swivelling movement;

FIG. 17 shows a side view of the pedal mechanism of FIG. 16

FIG. 18 shows a front view of the pedal mechanism of FIG. 16;

FIG. 19 shows a first perspective view of the pedal mechanism from above;

FIG. 20 shows a second perspective view of the pedal mechanism from above;

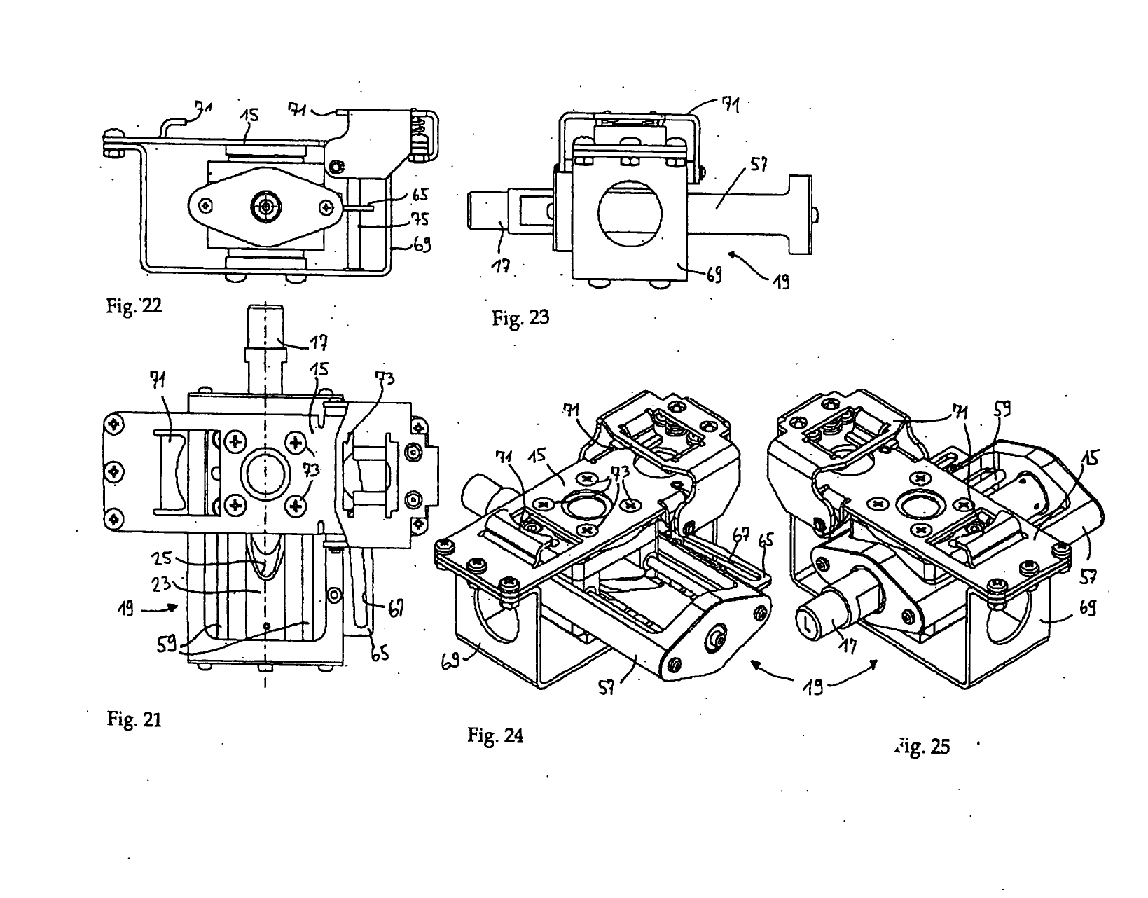

FIG. 21 shows the pedal mechanism of FIG. 16 with shoe support in plan view;

FIG. 22 shows the pedal mechanism of FIG. 21 in a side view;

FIG. 23 shows the pedal mechanism of FIG. 21 in a front view;

FIG. 24 shows a first perspective view of the pedal mechanism of FIG. 21;

FIG. 25 shows a second perspective view of the pedal mechanism of FIG. 21;

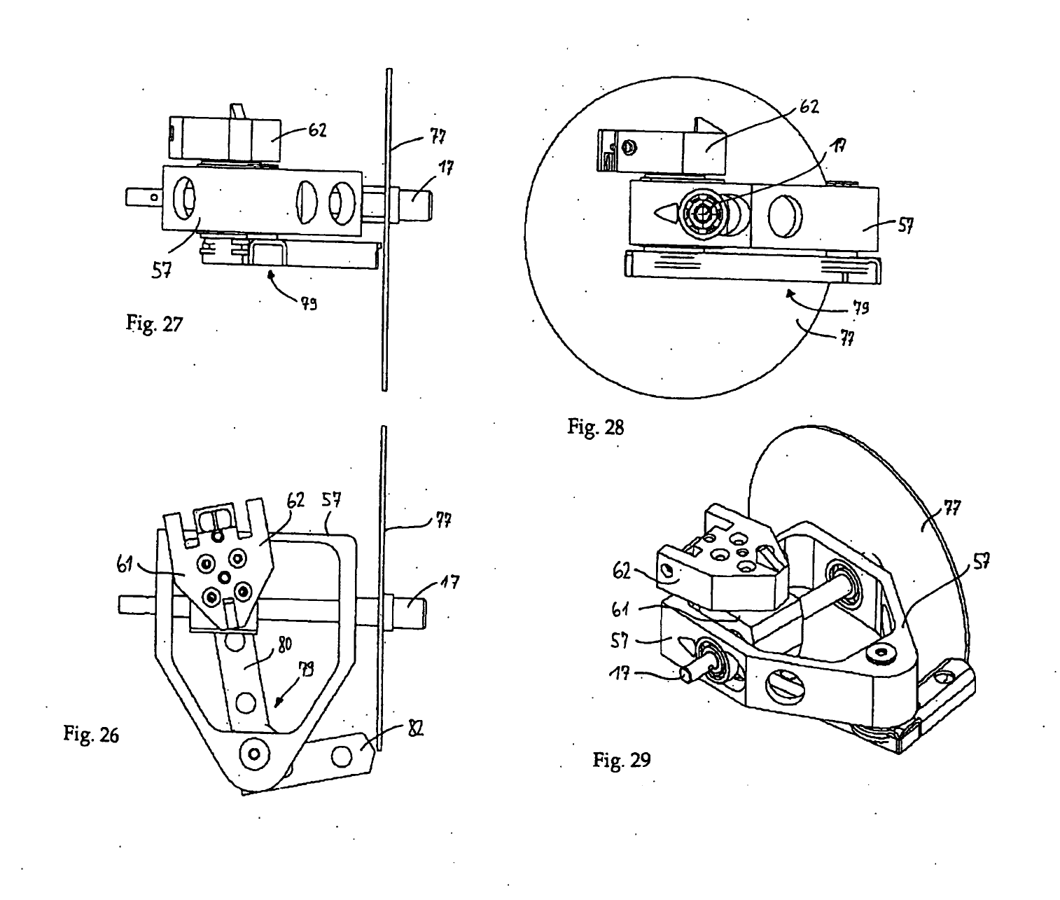

FIG. 26 shows an eighth embodiment of a pedal mechanism in plan view;

FIG. 27 shows the pedal mechanism of FIG. 26 in a front view;

FIG. 28 shows the pedal mechanism of FIG. 26 in a side view;

FIG. 29 shows the pedal mechanism of FIG. 26 in a perspective view;

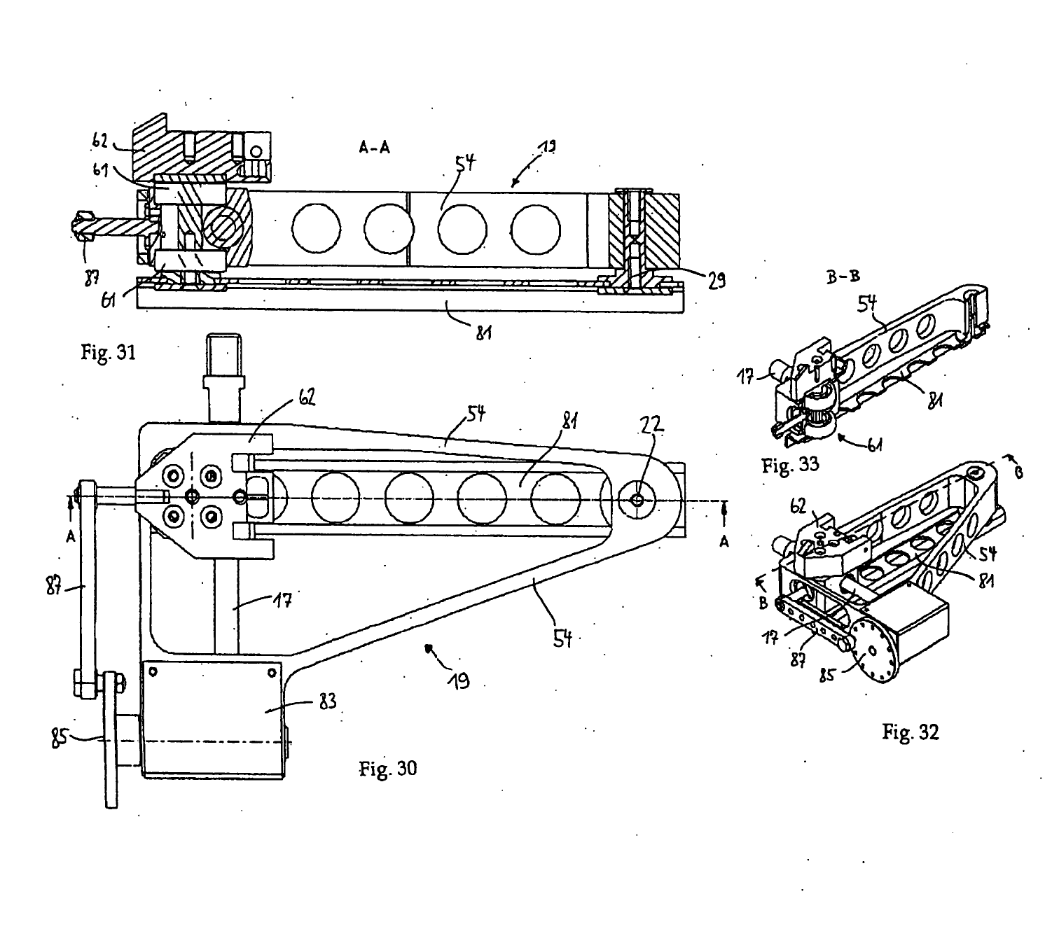

FIG. 30 shows a ninth embodiment of a pedal mechanism in plan view;

FIG. 31 shows the pedal mechanism of FIG. 30 in a side view;

FIG. 32 shows the pedal mechanism of FIG. 30 in a perspective view;

FIG. 33 shows a section of the pedal mechanism along the line 33-33 of FIG. 32;

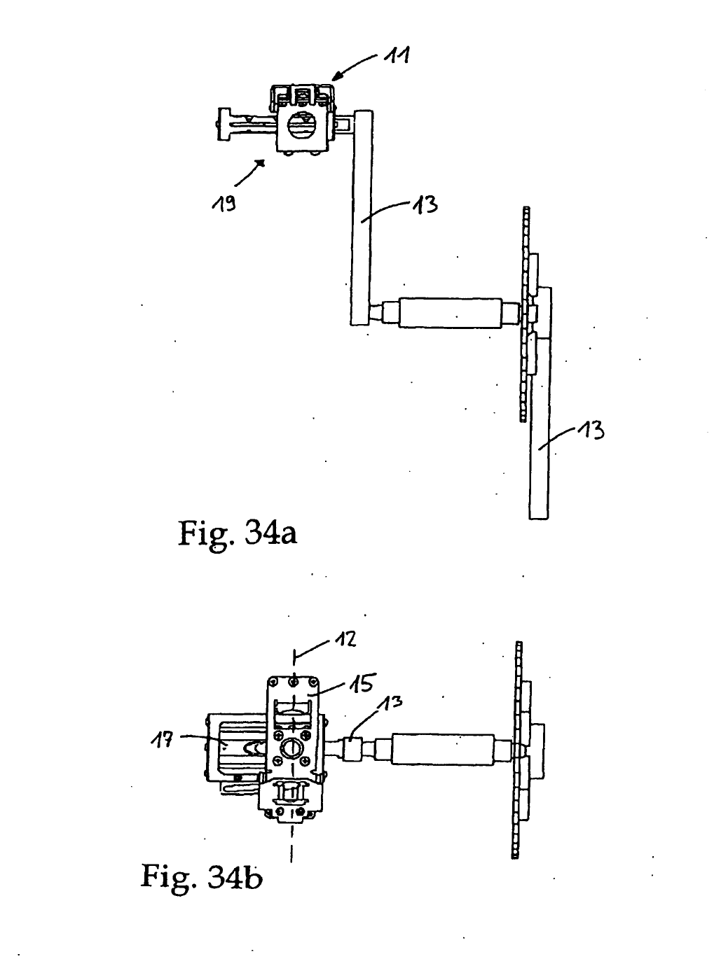

FIG. 34 shows a back view of a pedal mechanism according to the invention in the upper position of the pedal crank
a) in a back view
b) in plan view.

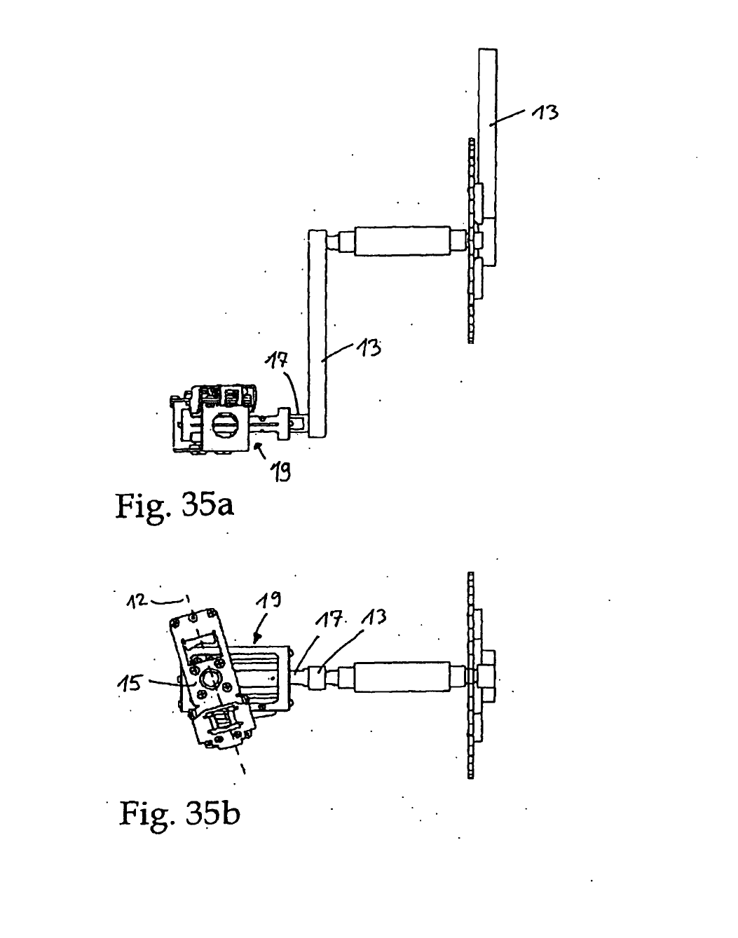

FIG. 35 shows a back view of a pedal mechanism according to the invention in the lower position of the pedal crank
a) in a back view
b) in plan view.

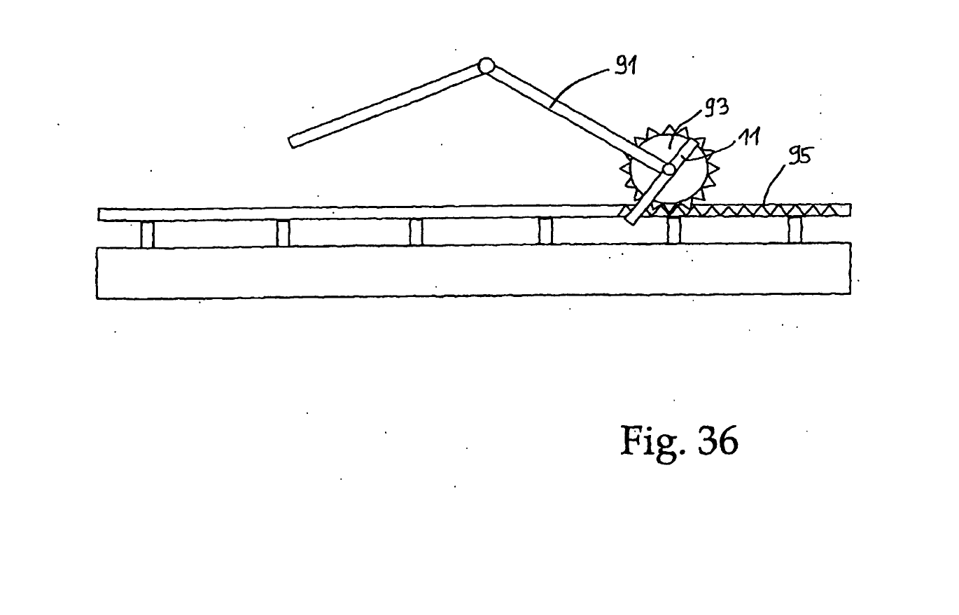

FIG. 36 shows a schematic illustration of a movement rail as is used in rehabilitation in orthopaedic surgery.

The pedal mechanism 11 according to the invention illustrated in FIGS. 1 to 4 is intended for assembly on a pedal crank arm 13 or a different type of pedal member, for example a bicycle, ergometer, stepper, etc. The pedal mechanism 11 comprises a support 19 which is rotatably mounted, for example on a pedal shaft 17, and on which a shoe support 15 is arranged. Within the scope of the present invention support is intended to designate the entire substructure on which the shoe support is arranged. The shoe support for example comprises an elongated plate which can have the contours of a foot (FIG. 4). The support 19 is rotatably arranged on the pedal shaft 17 by means of the bearing bushes 21. In the leading region of the shoe support 15 are provided two guide slots 20 (FIG. 4) which are located on a cam track with the swivel guide 22. The slots 20 are each penetrated by a screw 24. The screws 24 are screwed into the support 19 and guide and delimit, by variable positions, the swivelling movement of the shoe support 15.

According to the preferred embodiment of a pedal shown in FIGS. 1 to 4, a sleeve 23 is mounted between the bearing bushes 21 on the pedal shaft 17. A cam track in the form of a guide groove 25 is provided in the casing of the sleeve 23. The sleeve 23 is non-rotatably connected to the pedal shaft 17 by means of an adjustable fixing device, for example a stud bolt (not visible in the figure). A cam 27 which is provided on the lower side of the shoe support 15 engages in the guide groove 25. The shoe support 15 is supported on the sleeve 23 or the pedal shaft 17 by way of the cam 27. In the region of the heel the shoe support 15 is swivel-mounted by means of a pin 29, which engages in a hole 31 in the support 19, in a plane parallel to the pedal shaft 17. In FIG. 4 the course of the cam track is shown by reference numeral 33 (broken line).

The pedal mechanism according to the invention functions as follows: during cycling the pedal crank arm is driven, with the pedal shaft 17 that is non-rotatably connected to the pedal crank arm 13 also being rotated. The rotational movement of the pedal shaft 17 also causes the sleeve 23 that is permanently connected to the pedal shaft 17 to rotate. In the process the guide groove 25, by way of the cam 27 guided in the guide grove 25, forces a lateral swivelling movement of the shoe support 15 corresponding to the course of the cam track 25. Consequently a continuous change in position may be achieved for the foot. When the pedal crank arm is positioned at the top, the longitudinal axis of the foot—with bent knee—points forward. When the pedal crank arm is positioned at the bottom, the longitudinal axis of the foot—with stretched knee—points outward. By combining axial movements with each other, joint positions that conform to anatomy and kinesiology, such as supination position with bent knee and pronation position of the foot with stretched knee, may also be achieved and converted into needs-based continuity of movement. If the sleeve 23 is omitted a pedal or a pedal mechanism 11 is obtained which allows the user's feet to be automatically guided into the most suitable angular position with respect to the body.

The swivelling/rotational movement is advantageously combined with an inclined movement of the pedal shaft. This inclined movement can basically take place in the same manner as is described in U.S. Pat. No. 5,199,324. The content of this specification is hereby incorporated by means of reference. In contrast to U.S. Pat. No. 5,199,324 however, from functional anatomical perspectives the pedal should be mounted on the pedal crank in such a way that in the uppermost position it executes an inclination toward the ground and in the lowermost position an inclination away from the floor.

According to a further preferred embodiment of the invention the shoe support may also be swivelled about an axis 22 which is located in the heel region and is at a right angle to the pedal shaft. In FIG. 5a the shoe support 15 is arranged via a rail-slide system 35 on the pedal shaft 17 or on the bearing bushes 21. At least one guide rail or guide groove 37, which for example forms a detail of a circumference, of which the swivel guide 22 is located in the region of the heels, allows a swivelling movement sequence. A guide member 38, for example a sliding bolt or the like, engages in the guide groove 37. In the upper vertical pedal crank arm position the longitudinal axis 12 of the shoe support may thus be parallel to the plane in which the pedal crank arm moves. From here it may move downward, more or less automatically or trained by a movement pattern, in any case analogous to the forced sequence due to the tibia torsion however, and outward, i.e. out of the plane. In the lower vertical pedal crank arm position the toe-end may therefore point outward to the maximum. The movement transitions are fluid. The swivel angle a (designated by reference numeral 16 in FIG. 5a) is formed by the changing positions of the longitudinal axis 12 of the foot in the swivelling plane. In contrast to the illustrated embodiment it is also conceivable for the guide groove 37 to be provided at the lower side of the shoe support 15 and the guide member on the support.

FIG. 5b shows the rail-slide solution 35, illustrated in FIG. 5a, in section. Opposing the shoe support 15 there is provided on the pedal mechanism 11 a device for generating a predetermined, desired position of the shoe supporting surface in accordance with the centre of gravity. This device can for example be in the form of a weighted shape 39 that is provided on the lower side. The weighted shape 39 causes the shoe support 15 to point upward and to tend in a horizontal, or almost horizontal, position.

According to a development of the embodiment according to FIGS. 5a and b the rail or the rails are also convexly curved (FIG. 6a). The shoe support 15 can accordingly execute combined movements. FIG. 6a shows the possible position of the shoe support 15 if the pedal crank arm 13 points upward. FIG. 6a shows the possible position of the shoe support if the pedal crank arm 13 points downward. Basically, the rail-slide solution can however also be constructed between shoe and shoe supporting surface.

The pedal mechanism according to the invention has the following advantages: the rotational movement, known per se, of the pedal about the pedal shaft (ensures dorsal extension and plantar flexion of the foot in the upper ankle joint) is supplemented by a swivelling movement in the plane of the shoe supporting surface (ensures the rotational requirement by the tibia torsion) and may also be supplemented by a tilting movement. This unlimited freedom of movement allows a supination and pronation movement of the lower ankle joint for the first time. The axis of this “supination movement” runs analogously to that of the lower ankle joint.

This developed embodiment of the pedal mechanism thus conforms to the character of an at least three-axis joint which allows the foot to adopt any desired position in a space. Joint movements in one plane may be accompanied by accessory movements in the remaining planes. One-axis movements may be converted into combined and complex movements.

The embodiment of the invention according to FIGS. 5a and b and/or FIGS. 6a and b may comprise a heel support construction analogous to FIGS. 1 to 4 which may be rotatably mounted or mounted in the manner of a ball-and-socket joint.

The embodiment according to FIG. 7 provides that the pedal shaft 17 and the pedal mechanism 11 are coupled to each other in such a way that with a rotation about the pedal shaft 17 the pedal mechanism 11 or the shoe support 15 executes a swivelling movement and in addition a tilting movement out of the plane of the swivelling movement. This type of movement pattern of the pedal or the shoe support may be achieved by means of a cam track 33 formed on the pedal shaft or on the lower side of the shoe support and which is provided on a truncated cone 41. The shoe support 15 can in the process be supported on the one hand by a support bracket 14 or directly on the cam track 33 or the truncated cone 41, and equally on the other hand by the support bracket 14 or directly on a telescopically displaceable bearing bush 43 which can run on or in the pedal shaft 17.

If the shoe support 15 is constructed in one piece an inclination of the entire shoe support thus results. If the shoe support is of two-part or multi-part construction an inclination of only the forefoot may be achieved.

FIG. 8 shows a pedal mechanism, which has been modified with respect to the embodiment of FIG. 7, without heel support construction and in which the shoe support is constructed in two parts. A resilient connecting element 45 is provided between the leading and the trailing parts of the shoe supporting surface 15′ and 15″ respectively.

FIGS. 9a and b show the novel pedal mechanism mounted on a pedal crank in two different positions.

FIGS. 10a and 10b show a pedal mechanism with a rail-slide system (only rail system illustrated) with two pedal supports 47, which are trough-shaped in section, provided on the pedal mechanism and at the inner side of which a guide groove 33 has been worked in. The guide groove 33 extends in such a way that a swivelling movement in a plane parallel to the pedal shaft 17 and a tilting movement out of this plane are made possible. On displacement of the shoe support 15 from one extreme position into the other, in which the shoe support is tilted, it therefore passes through a valley in which the shoe support extends parallel to the pedal shaft.

In principle it is conceivable for the swivelling movement and/or tilting movement of the shoe supporting surface to be brought about by a cam and/or coupler mechanism. The mechanism and/or the mechanism combinations may be positioned as connecting members between pedal crank, pedal crank arm, pedal shaft, support and foot supporting surface and/or be constructed and positioned in any desired interaction.

The pedal mechanism illustrated in FIGS. 11 to 15 corresponds to a commercial embodiment of the pedal mechanism of FIGS. 1 to 4. Lugs 51 with slots 53 are provided on the side of the shoe support 15 and are used for fastening a shoe with the aid of straps (not shown). A heel support 54 is used to support the shoe support 15 in the heel region. The heel support 54 is arranged with its first end on the bearing bushes 21 and articulated with its second end to the shoe support (pivot point 22). A pin 29, which is rotatably mounted in a sleeve 56, allows the shoe support 15 to swivel along a cam track.

The pedal mechanism 11 according to FIGS. 16 to 25 shows a further way in which swivelling of the shoe support 15 relative to the pedal shaft 17 may be achieved. The pedal mechanism 11 has a support 19 comprising a frame 57 on which two guide rods 59 are arranged parallel to the pedal shaft 17. A slide 61 is arranged so as to reciprocate on the guide rods 59. A ball bearing 63 for receiving a shoe support 15 is provided on the slide 61. On the lower side of the slide 61 there is provided—analogously to embodiments already discussed above—a pin 29 (not visible in the figures) which engages in the guideway 25 of the sleeve 23. Consequently, the slide 61 is reciprocated when the sleeve 23 rotates relative to the support. A projection 65, extending over part of the support width, with a slot 67 is provided on the front of the frame 57. The slot 67 is used as a restricted guidance for the movable shoe support 15 and to force a combined swivelling and rotational movement of the shoe support 15 relative to the pedal shaft 15, as will be described in more detail hereinafter. By omitting the sleeve 23 a pedal mechanism is obtained which allows the user's feet to be automatically guided into the most suitable angular position with respect to the body.

The support designated by reference numeral 19 is used quite generally to receive the shoe support 15. The shoe support 15 rests on the rotatable ball bearing 63 and is therefore rotatable relative to the support. The shoe support 15 has a U-shaped bracket 69 which connects the front and back parts of the shoe support 15. A known click device 71, which is used for detachably fastening a cycle shoe that is used nowadays, is also located on the shoe support. The shoe support 15 is connected by means of four screws 73 to the ball bearing 63. A pin 75, which extends through the slot 67, is located on the lower side of the shoe support 15.

This pedal mechanism functions as follows: when the pedal mechanism rotates about the pedal shaft the slide 61 is reciprocated. The shoe support 15 arranged on the slide 61 is guided by the pin 75 in the slot 67. Since the slot 67 extends at an angle to the pedal shaft 17 the shoe support 15 must inevitably swivel if it is displaced in the direction of the pedal shaft. Basically, the path described by the slot 67 can extend in a straight line or be curved.

The pedal mechanism in FIGS. 27 to 29 has an eccentric disc 77 which is non-rotatably arranged on the pedal axis 17. In a manner similar to the previous embodiment a slide 61 is also provided here which is movably arranged on the pedal shaft 17. An angle lever 79 is rotatable about an axis of rotation 22 which runs through the frame 57. The one arm 80 of the angle lever 79 is connected to the slide 61 and a receiver 62 arranged on the slide 61, and the other arm 82 of the angle lever 79 cooperates with the circumference of the eccentric disc 77. The receiver 62 is used to receive a shoe support. When the pedal mechanism revolves the angle lever 79, and therefore the receiver, is swivelled about the axis of rotation 81 to correspond with the variable radius of the eccentric disc 77.

The embodiment of FIGS. 30 to 33 differs from the previous ones in that a small gear 83 is provided. The pedal shaft 17 drives a movement converter 85, which is connected by a linkage 87 to the slide 61, via gear elements (not shown). The slide 61 is reciprocated on the pedal shaft 17 by the movement converter 85. The receiver 62 is non-rotatably connected to a lever 81 which is articulated to the lower end of the heel support 54 and is rotatable about the pivot point 22. As a result the gear 83 brings about a rotation of the receiver about the pivot point 22 in addition to a reciprocating movement.

FIGS. 34 and 35 show a pedal mechanism of the invention according to FIGS. 16 to 25 mounted on a pedal crank arm of a bicycle. Two extreme positions, an upper position of the left-hand pedal crank arm (FIGS. 34a and 34b) and a lower position of the left-hand pedal crank arm (FIGS. 35a and 35b) are shown. It may clearly be seen that in the upper position of the pedal crank arm the longitudinal axis of the shoe support 15 extends parallel to a plane which is defined by the rotating pedal crank arm. In the lower position of the pedal crank arm the longitudinal axis of the shoe support 15 has executed an outward swivelling movement.

FIG. 36 shows use of the pedal mechanism according to the invention in connection with a movement rail 91. While with the conventional movement rail the foot is stationary when the knee bends and stretches, when using the pedal mechanism according to the invention mobility of the foot is achieved. A physiological swivelling movement of the foot may take place. In the foot region the movement rail can comprise a gear mechanism, shown here by way of example by interaction of toothed wheel 93 and toothed rack 95. A swivelling movement of the foot may also be forced by this kind of gear mechanism.

The extent of the individual movements and their interaction can be fixed and limited in all embodiments according to the invention by appropriate construction modules by way of their production and selection. The individual construction modules may be adapted, adjusted, exchanged and combined as required.

Desired settings and sequences may be variably executed during use. Fixing means are preferably provided between the shoe support and the shoe for detachable fastening. The fixing means may be formed by straps, mesh-like casings, a snap connection or the like. The fixing means may be known connection systems, as are used for example in bicycles.

A spacer for fastening-side extension of the pedal shaft is advantageously provided. This has the advantage that the “track width” of the leg position may be better satisfied. The shoe supporting surface can correspond in terms of size to the entire sole of the foot.

In a preferred embodiment the pedal mechanism according to the invention has a shoe supporting surface which matches the size of conventional forefoot pedals.

The shoe support can be constructed with or without heel support for all embodiments according to the invention and be constructed in one, two or multiple parts. With a two-part or multi-part construction the parts are preferably resiliently connected to each other. The shoe support can be constructed so as to conform with the anatomical requirements and for example have an orthesis function.

To maintain the health of the active and passive musculoskeletal system it is necessary not only to move it sufficiently but also to pay regard to structural, functional and axial-compliant stressing in particular.

Conventional harmful movement patterns may be corrected by a needs-based functional morphological movement range. Specific mobility directions may also be intensified and intended extents and limits of movement may be achieved. Movement sequences may be assisted, controlled and reproduced in accordance with findings. Passive execution of a movement may be achieved more safely. If desired movement patters are achieved or if the test person has sufficient coordinative capacities, restricted guidance may be dispensed with. These aspects, relating to said movement sequences, can be achieved for the first time by the present invention.

### REFERENCE NUMERALS

11 pedal mechanism (pedal)

12 (foot) longitudinal axis of the shoe support

13 pedal crank arm

14 support bracket

15a—shoe support

16 swivel angle of the shoe support

17 pedal shaft

19 support

20 guide slot

21 bearing bushes

22 swivel guide of the circular path

23 sleeve

24 screws

25 guideway

27 cam

29 pin

31 hole

33 cam track of the sleeve 23

35 rail-slide system

36 stops

37 guide rail

38 guide member

39 weighted form

41 truncated cone

43 bearing bush

45 resilient connecting element

47 pedal supports

51 lugs

53 slots

54 heel support

55 support

56 sleeve

57 frame

59 guide rods

61 slide

62 receiver

63 ball bearing

65 projection

67 slot

69 U-shaped bracket

71 click device

73 screws

75 pin

77 eccentric disc

79 angle lever

80 first arm of the angle lever

81 lever

82 second arm of the angle lever

83 gear

85 movement converter

91 movement rail

93 toothed wheel

95 toothed rack

1. A pedal mechanism for use in a bicycle, ergometer or other therapy, rehabilitation or fitness device which is used in actively or passively bending and stretching a leg or for carrying out combined movement sequences that include this movement, in particular the complex movement sequences of the feet as a consequence thereof, comprising
a support and
a foot or shoe support arranged on the support, whereby the shoe support is movably arranged on the support in such a way that a swiveling movement at an angle to the longitudinal extension of the shoe support is made possible.

2. The pedal mechanism according to claim 1, wherein the swiveling movement takes place along a curved path of movement.

3. The pedal mechanism according to claim 1, wherein a pedal shaft is provided and the shoe support and the support are coupled to each other in such a way that when the pedal mechanism rotates about the pedal shaft the shoe support executes a swiveling movement relative to the support.

4. The pedal mechanism according to claim 1, wherein a pedal shaft is provided and the shoe support and the support are coupled to each other in such a way that when the pedal mechanism rotates about the pedal shaft the shoe support executes a rotational and swivelling movement relative to the support.

5. The pedal mechanism according to claim 1, wherein the shoe support can be swiveled in a plane which lies parallel to the pedal shaft.

6. The pedal mechanism according to claim 3, wherein mutually cooperating guide means are formed on the pedal shaft and the shoe support in such a way that when the pedal mechanism rotates the shoe support executes at least one swiveling movement in the plane of the shoe support.

7. The pedal mechanism according to claim 3, wherein a groove or guideway is formed on the pedal shaft and a cam is formed on the shoe support and the cam meshes in the guideway.

8. The pedal mechanism according to claim 7, wherein a sleeve can be positioned on the pedal shaft and in which the groove or guideway is formed.

9. The pedal mechanism according to claim 3, wherein the shoe support is guided, by means of at least one slide or rail system provided on the pedal mechanism in a plane extending parallel to the pedal shaft, along a path of movement.

10. The pedal mechanism according to claim 9, wherein the path of movement corresponds to a cam track and a swivel guide located in a heel region of the support.

11. The pedal mechanism according to claim 6, wherein the path of swivel movement corresponds to a cam track located in a heel the region of the support and the path of swivel movement is also convexly curved.

12. The pedal mechanism according to claim 3, wherein the support has a slide which may be reciprocated during operation by a gear which is configured to be driven by the pedal shaft that is non-rotatably connected to a pedal crank.

13. The pedal mechanism according to claim 12, wherein provided on the support are two guide rods on which the slide (61) is arranged so it can be reciprocated, wherein provided on the slide is a first cam which engages in a first guideway on the pedal shaft and a second guideway on the support configured to engage a second cam arranged on the shoe support which is rotatably mounted on the slide.

14. The pedal mechanism according to claim 12, wherein pivotally arranged on the support is an angle lever which with a first arm cooperates with the slide and a second arm configured to cooperate with an eccentric disc non-rotatably connected to the pedal shaft.

15. The pedal mechanism according to claim 3, wherein provided on the support is a gear configured to be driven by the pedal shaft and provided on the gear (83) is a movement converter which is connected via a linkage to a slide.

16. The pedal mechanism according to claim 15, wherein at the back of the support a heel support is formed and to which a lever is rotatably coupled to the slide.

17. The pedal mechanism according to claim 1, wherein the shoe support is formed by a shoe sole.

18. The pedal mechanism according to claim 1, wherein the swiveling movement is combined with a tilting movement of the shoe support.

19. The pedal mechanism according to claim 3, wherein the pedal shaft and the shoe support are coupled to each other in such a way that on a rotation about the pedal shaft, the shoe support, in the region of a foot, also executes a tilting movement out of the plane of the shoe support.

20. The pedal mechanism according to claim 3, wherein a cam track is formed on the pedal shaft and is connected to the shoe support in such a way that on rotation of the pedal mechanism about the pedal shaft the shoe support executes a swivelling movement in the plane of the shoe support and out of this plane.

21. The pedal mechanism according to claim 3, wherein a truncated cone-shaped sleeve with a cam track is non-rotatably arranged on the pedal shaft.

22. The pedal mechanism according to claim 21, wherein the shoe support is supported on a sleeve or cam track connected to the pedal shaft.

23. (canceled)

24. The pedal mechanism according to claim 1, wherein the pedal shaft can be telescopically extended.

25. The pedal mechanism according to claim 1, wherein the shoe support is constructed according to anatomical requirements and has an orthesis function.

26. The pedal mechanism according to claim 1, wherein provided on the support is a heel support on which the shoe support is arranged in the heel region so as to be rotatable.

27. The pedal mechanism according to claim 3, wherein fixing means for detachable fastening are provided on the shoe support.

28. The pedal mechanism according to claim 1, wherein a spacer for fastening-side extension of the pedal shaft is provided.

29. (canceled)

30. The pedal mechanism according to claim 3, wherein the shoe support can be swivelled in an angular range of at least five degrees.

31. A bicycle, ergometer or other therapy, rehabilitation or fitness device for active or passive bending and stretching of the legs or for carrying out combined movement sequences that include this movement, in particular the complex movement sequences of the feet as a consequence thereof, comprising a pedal mechanism having a support and a foot or shoe support arranged on the support whereby the shoe support is movable arranged on the support in such a way that a swiveling movement at an angle to the longitudinal extension of the shoe support is made possible.

32. The bicycle, ergometer or other therapy, rehabilitation or fitness device according to claim 31, wherein the pedal mechanism is arranged on a pedal crank arm in such a way that the longitudinal axis of the shoe support, in the uppermost position of the pedal crank arm, extends substantially parallel to a plane which is defined by the rotating pedal crank arm, and, in the lowermost position of the pedal crank arm, the longitudinal axis of the shoe support is arranged at an angle to this plane.

33. The bicycle, ergometer or other therapy, rehabilitation or fitness device according to claim 31, wherein the pedal mechanism is arranged on a movement rail.

34. The bicycle, ergometer or other therapy, rehabilitation or fitness device according to claim 31, wherein that a movement converter is provided which converts a stretching movement into a rotation of a pedal shaft.
